(19) United States
(12) Patent Application Publication
(10) Pub. No.: US 2006/0005482 A1
(43) Pub. Date: Jan. 12, 2006

(54) Point attachment systems for laminated glass and a process for preparing same

(76) Inventors: Stephen J. Bennison, Wilmington, DE (US); Bjorn A. Sanden, Ossendrecht (NL)

Correspondence Address: E I du Pont de Nemours & Company, Legal Patents, Wilmington, DE, 19898, US

(21) Appl. No.: 10/519,651

(22) PCT Filed: Jul. 31, 2003
(86) PCT No.: PCT/US03/24118

§ 371 Date: Dec. 27, 2004

(51) Int. Cl. E06B 3/00

(52) U.S. Cl. 52/204.5

(57) ABSTRACT

The present invention is a direct-point attachment glazing (bolted glass) system (20) comprising: (1) a polymer interlayer (28); (2) at least one sheet of glass (24); (3) at least one receptor for an attachment means; and (4) at least one attachment means, wherein the polymer interlayer (28) is bonded on at least one surface to at least one sheet of glass (24), and wherein at least one receptor (22) is adhesively bonded to the glass by the polymer interlayer (28) in such a way that the receptor (28) is positioned to mechanically accept the attachment means.

This Application claims the benefit of U.S. Provisional Application No. 60/400,234, filed Jul. 31, 2002.

### BACKGROUND OF THE INVENTION

Laminated glass can be useful in homes and buildings; shelving in cabinets and display cases; and other articles where improved safety performance is desirable in glass. In architecture, there can be advantages in attaching glass to frames and building support structures by means of direct point-support systems that employ bolts and/or other non-adhesive fasteners. For example, bolted glazing systems allow for the design of high vision area, highly transparent facades. U.S. Pat. No. 4,406,105 and U.S. Pat. No. 4,680,206, and EP No. 0 735 227 B1 teaches the use of point-attachment systems for structural glass assemblies.

Producing glazing systems that can be fastened to support structures via direct-point attachment (hereinafter “bolted glass”) is not trouble free. Using bolted glass systems can be difficult due to various factors inherent in a conventional bolted glass process. For example, bolted glass systems require the use of tempered glass, which can result in reduced optical clarity and pose a risk of spontaneous breakage due to Nickel Sulfide inclusions and service-induced deep scratches.

Conventional laminated safety glass generally comprises thermoplastic sheeting bonded between sheets of glass or other transparent plastic materials. These laminated glass composites are required to perform to stringent requirements including impact performance, weatherability, and transparency. However, the presence of the polymer interlayer can also cause difficulties when using bolted glass. If the glass is broken accidentally, the attachment of the bolted system is maintained by clamping across random glass fragments minimally attached to the interlayer. The concentrated connection forces that are characteristic of bolted glass often cause the broken glass fragments to cut through the interlayer thus severing the connection between the bolted glass laminate and building support structure. This cutting of the interlayer is exacerbated at elevated temperatures of 50° C. and greater due to interlayer creep. This performance challenge is manifest in diminished post-glass breakage integrity of a bolted glass laminates after accidental glass breakage.

Another concern when using bolted glass laminates is keeping the holes of the interlayer aligned with the holes in the glass during the laminating process. U.S. Pat. No. 5,787,662 describes elaborate construction elements that attempt to deal with this issue of hole alignment between glass plies. There are still further problems that can occur with bolted laminated glass systems relative to the compatibility between the interlayer and the fastener, and also the durability of the attachment. Interlayer-glass delamination problems are commonly seen around the attachment holes required to accommodate the bolt fixtures. Where bolted laminated glass is employed for enhanced safety, one glass-ply and polymer interlayer are often treated as a redundant structural components. EP 0 651 113 B1 claims an attachment system for bolted glass laminates that structurally utilizes one ply of glass only in the laminate. U.S. patent application 2002/0020119 A1 teaches the use of special holder point attachment systems to allow optimum design of bolted glass and bolted glass laminates.

It can be desirable to have a bolted glass laminate and simple attachment system that can overcome the problems of a conventional bolted glass and bolted laminated glass systems.

### SUMMARY OF THE INVENTION

In one aspect, the present invention is a direct-point attachment glazing (bolted glass) system comprising: (1) a polymer interlayer (2) at least one sheet of glass; (3) at least one receptor for an attachment means; and (4) at least one attachment means, wherein the polymer interlayer is bonded on at least one surface to at least one sheet of glass, and wherein at least one receptor is adhesively bonded to the glass by the polymer interlayer in such a way that the receptor is positioned to mechanically accept the attachment means.

In another aspect the present invention is a process for preparing a glazing system suitable for direct-point attachment to a support structure comprising the steps: assembling a glass laminate comprising (1) a polymer interlayer (2) at least one sheet of glass; (3) at least one receptor for an attachment means; and (4) at least one attachment means, wherein the polymer interlayer is bonded on at least one surface to at least one sheet of glass, and wherein at least one receptor is adhesively bonded to the glass by the polymer interlayer in such a way that the receptor is positioned to mechanically accept the attachment means.

### BRIEF DESCRIPTION OF THE DRAWINGS

FIG. 1 is section view of a bolted glass system comprising a first and a second glass ply bonded together by a polymer interlayer and further comprising a cylindrical threaded receptor that is open at one end for receiving an attachment means and closed at one end, wherein the receptor is embedded in the interlayer on all sides with the exception of the open end which is exposed at the surface of the first glass ply, and wherein the receptor does not pass below the surface of the second ply of glass.

FIG. 2 is a variation of FIG. 1 except that the receptor further comprises a lip that projects from the bottom portion of the closed end of the receptor essentially parallel to the surface of the glass and fully embedded in the thermoplastic polymer interlayer.

FIG. 3 is a variation of FIG. 1 except that the receptor passes through both plies of glass, the closed end of the receptor being flush with the exposed surface of the second glass ply.

FIG. 4 is a variation of FIG. 3 except that the receptor further comprises a lip that projects from the bottom portion of the closed end of the receptor essentially parallel the surface of the glass. The lip is bonded to the glass surface with a thin layer of polymer.

FIG. 5 is a variation of FIG. 1 except that the receptor comprises a countersunk geometry to allow flush mounting with one internal glass surface. The countersunk receptor wall is bonded to the countersunk glass hole with a thin layer of the polymer.

FIG. 6 is a variation of FIG. 5 except the countersunk receptor extends past one inner glass surface and is fully embedded in the polymer interlayer.

FIG. 7 is a variation of FIG. 5 except that the receptor comprises a countersunk geometry to allow flush mounting with one external glass surface. The countersunk receptor wall is bonded to the countersunk glass hole with a thin layer of polymer and the shaft of the receptor continues through the laminate and until the open end is flush with the external surface of the other glass ply. Attachment of the fastener is made to the open end of the receptor.

FIG. 8 is a variation of FIG. 3 except that the receptor is a dual receptor that is open on each end to both exposed glass surfaces, and can accept an attachment means from either glass surface.

FIG. 9 is a variation of FIG. 8 except that the receptor in FIG. 9 further comprises a lip that projects into the interlayer interspersed between the two glass plies.

FIG. 10 is a receptor device that is embedded within the laminate and bonded directly to the polymer interlayer. It provides an internal solid surface for attachment of a fastener device.

FIG. 11 is a variation of FIG. 10 in which the receptor is again embedded in the laminate and is of such dimensions to be flush with the edges of the hole. Attachment is made to the fastener via a threaded surface on the receptor.

### DETAILED DESCRIPTION OF THE INVENTION

### DETAILED DESCRIPTION OF THE FIGURES

FIG. 1 is a sectional view of a bolted glass system (10) comprising a first glass ply (14) and a second glass ply (16) bonded together by a polymer interlayer (18) and further comprising a cylindrical threaded receptor (12) that is open at one end for receiving an attachment means and closed at one end, wherein the receptor is embedded in the interlayer on all sides with the exception of the open end which is exposed at the surface of the first glass ply, and wherein the receptor does not pass below the surface of the second ply of glass.

FIG. 2 is a sectional view of a bolted glass system (20) comprising a first glass ply (24) and a second glass ply (26) bonded together by a polymer interlayer (28) and further comprising a cylindrical threaded receptor (22) that is open at one end for receiving an attachment means and closed at one end, the closed end further comprises a lip (21) that projects from the bottom of the closed end, wherein the receptor is embedded in the interlayer on all sides with the exception of the open end which is exposed at the surface of the first glass ply, and wherein the receptor does not pass below the surface of the second ply of glass.

FIG. 3 is sectional view of a bolted glass system (30) comprising a first glass ply (34) and a second glass ply (34) bonded together by a polymer interlayer (36) and further comprising a cylindrical threaded receptor (32) that is open at one end for receiving one attachment, wherein the receptor is embedded in the interlayer on all sides with the exception of the open end, which is exposed at the surface of the first glass ply, and the closed end of the receptor which is flush with the exposed surface of the second glass ply.

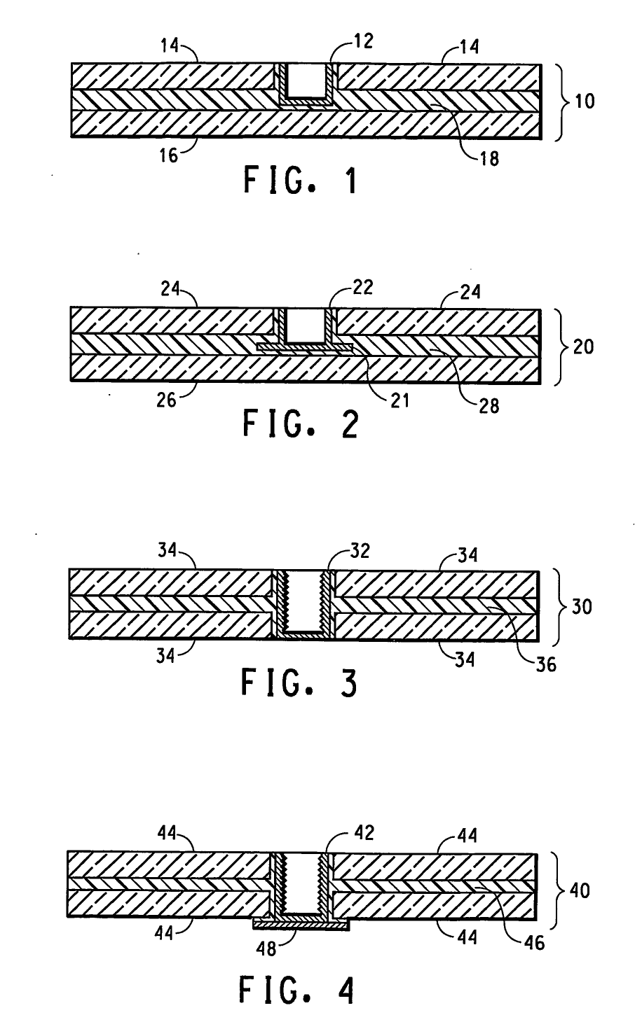

FIG. 4 is a sectional view of a bolted glass system (40) comprising a first glass ply (44) and a second glass ply (44) bonded together by a polymer interlayer (46) and further comprising a cylindrical threaded receptor (42) that is open at one end for receiving one attachment, wherein the receptor is embedded in the interlayer on all sides with the exception of the open end, which is exposed at the surface of the first glass ply, and the closed end of the receptor which is essentially flush with the exposed surface of the second glass ply and further comprises a lip (48) which is bonded to the surface of the second glass ply with a thin layer of the polymer interlayer (46).

FIG. 5 is a sectional view of a bolted glass system (50) comprising a first glass ply (54) and a second glass ply (56) bonded together by a polymer interlayer (58) and further comprising a countersunk threaded receptor (52) that is open at one end for receiving an attachment means and closed at one end, wherein the receptor is flush-mounted with the interior surface of the first glass ply, and contacted by the interlayer on all sides with the exception of the open end, which is exposed at the surface of the first glass ply, and wherein the receptor does not pass below the surface of the second ply of glass.

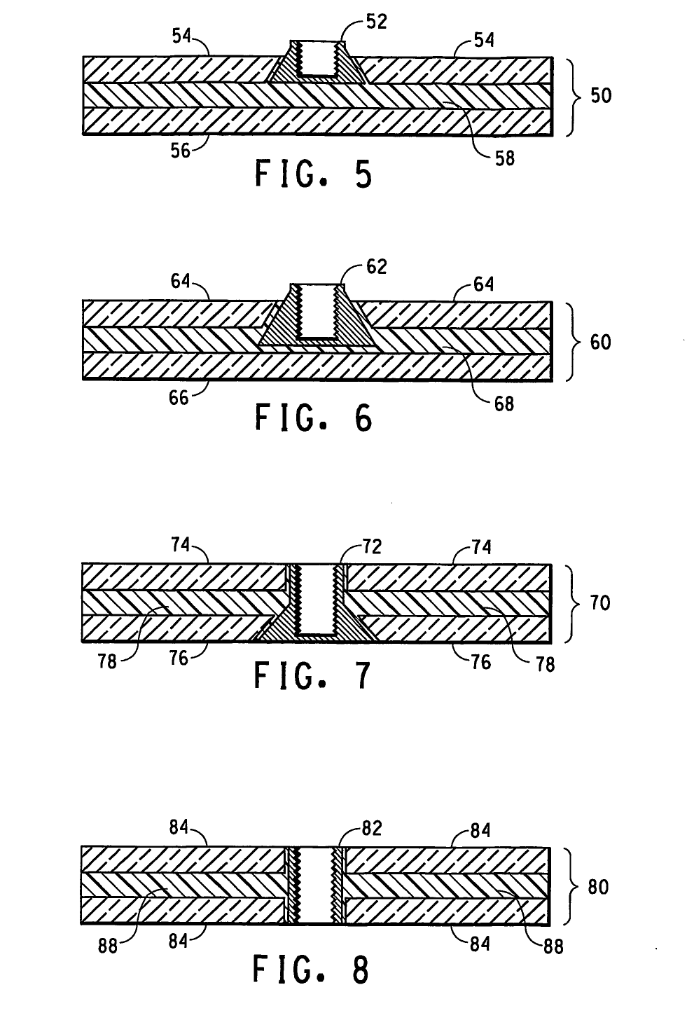

FIG. 6 is a sectional view of a bolted glass system (60) comprising a first glass ply (64) and a second glass ply (66) bonded together by a polymer interlayer (68) and further comprising a countersunk threaded receptor (62) that is open at one end for receiving an attachment means and closed at one end, wherein the receptor is embedded in the interlayer on all sides with the exception of the open end which is exposed at the surface of the first glass ply, and wherein the receptor does not pass below the surface of the second ply of glass.

FIG. 7 is a sectional view of a bolted glass system (70) comprising a first glass ply (74) and a second glass ply (76) bonded together by a polymer interlayer (78) and further comprising a countersunk threaded receptor (72) that is open at one end for receiving an attachment means and closed at one end, wherein the open end of the receptor is flush-mounted with the external surface of the first glass ply and the closed end of the receptor is flush-mounted with the external surface of the second glass ply, and contacted by the interlayer on all sides with the exception of the open and closed ends which are exposed at the external surfaces of the glass plies.

FIG. 8 is a sectional view of a bolted glass system (80) comprising a first glass ply (84) and a second glass ply (84) bonded together by a polymer interlayer (88) and further comprising a cylindrical threaded receptor (82) that is open at both ends for receiving at up to two attachments, wherein the receptor is embedded in the interlayer on all sides with the exception of the open ends which are exposed at the surfaces of the glass plies, the ends of the receptors being flush with the exposed surfaces of the glass.

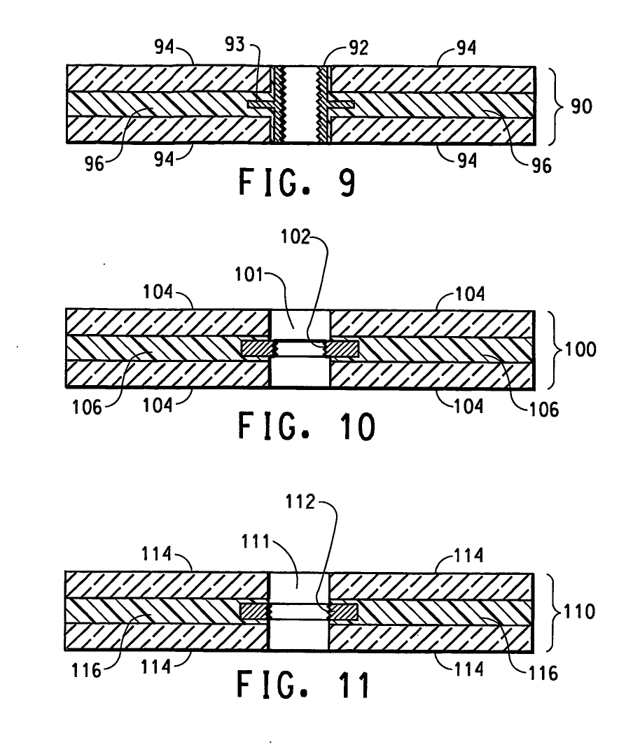

FIG. 9 is a sectional view of a bolted glass system (90) comprising a first glass ply (94) and a second glass ply (94) bonded together by a polymer interlayer (96) and further comprising a cylindrical threaded receptor (92) that is open at both ends for receiving at up to two attachments, wherein the receptor further comprises a lip (93) that projects from the receptor, and the receptor is embedded in the interlayer on all sides with the exception of the open ends which are exposed at the surfaces of the glass plies, the ends of the receptors being flush with the exposed surfaces of the glass.

FIG. 10 is a sectional view of a bolted glass system (100) comprising a first glass ply (104) and a second glass ply (104) bonded together by a polymer interlayer (106) and further comprising an internal threaded receptor (102) inside an opening (101) in the glass system, wherein the receptor provides a solid surface for attachment of an attachment means, wherein the threads are inset from the opening.

FIG. 11 is a sectional view of a bolted glass system (110) comprising a first glass ply (114) and a second glass ply (114) bonded together by a polymer interlayer (116) and further comprising an internal threaded receptor (112) inside an opening (111) in the glass system, wherein the receptor provides a solid surface for attachment of an attachment means, wherein the threads are flush with the opening.

In one embodiment, the present invention is a system for direct attachment of a receptor system to a tough polymer interlayer. In the event of accidental glass breakage the integrity of the unit is maintained by transmitting any applied forces, for example self-weight, wind load and the like, through the polymer interlayer and receptor to the connection system to the building support system. This has a distinct advantage over conventional bolted laminated glass where system performance is determined by transmission of forces through broken glass fragments. This latter condition is limiting in that glass fragments often lead to cutting and piercing of the interlayer and often break free, particularly during cyclic loading, that is, where the force exerted by a load on the laminate cycles from a positive direction to a negative direction. Conventional bolted laminates are often seen to tear and pull loose from bolted fittings after accidental breakage. This problem is exacerbated at elevated temperatures, especially greater than 50° C. Further advantages of the systems sketched in FIGS. 1 through 9 include a lessened tendency for glass-polymer delamination in the vicinity of the hole since the glass-polymer interface is essentially sealed internally from the external ambient humidity, which can play a role in delamination mechanisms. The receptor systems sketched in FIGS. 1, 2, 5 and 6 require only one hole to be fabricated in one glass ply thus obviating difficulties in aligning two holes in two different glass plies. These receptor systems that bolt to one glass ply only will also facilitate the fabrication of bolted glass where insulated glass units, such as double and triple glazing are required for energy management.

The bolted glass systems disclosed herein allow all of the components—that is, glass, polymer and receptor—to be included as structural elements in the design of bolted glass laminates for transparent structural facades.

In another embodiment, the present invention is a glazing system comprising a polymer interlayer interspersed between at least two plies of glass wherein the glazing system can be attached to a support structure by direct-point attachment, wherein the direct point attachment is via a receptor for an attachment means, said receptor being embedded in the interlayer in such a manner as to accept the attachment means for attachment to said support structure. Glass may be any one of the standard types: annealed, heat-strengthened or tempered, commonly used in architectural applications. The glass can be flat, curved, or tapered without affecting the practice of the present invention.

A support structure for the purposes of the present invention can be a window frame, a building, a wall, a panel, a ceiling, a floor, suspension wires, or any building structure or substructure having a load-bearing function.

A suitable attachment means can be any means for attaching the laminate to a support structure. Suitable attachment means can be, for example, bolts, clamps, nails, screws, rope, chains, tether, snaps, clips, and the like. With the proviso that the attachment means is sufficiently strong enough to form an appropriate support for the laminate structure.

A suitable receptor can be any feature that works together with an attachment means to form an attachment to a support structure. A suitable receptor can be constructed of any generally sturdy material such as: metals such as steel, aluminum, titanium, brass, lead, chrome, copper, and the like; engineering plastics such as polycarbonate, polyurethane, nylon, poly(alkyl)acrylates, poly(acetals) and the like; natural materials such as stone, wood, or the like. Materials should be chosen based upon compatibility with the polymer interlayer and to minimize internal stresses in the laminate structure such as those that may result from incompatibilities between the glass, the receptor, and/or the polymer interlayer.

A suitable tough polymer interlayer can be any that can form an adhesive bond with glass and also with the material of construction used to form the receptor for the attachment means. A suitable thermoplastic interlayer can be an acid copolymer formed by copolymerization of an ethylenically unsaturated carboxylic acid with ethylene, or an ionomeric polymer formed by full or partial neutralization of an acid copolymer. Suitable acid copolymer or ionomers can be purchased commercially from E.I. DuPont de Nemours and Company under the tradenames Surlyn® or Nucrel®, for example. Particularly preferred are thermoplastic polymers consisting essentially of a water insoluble salt of a copolymer of ethylene and methacrylic acid or acrylic acid containing 14-28 % by weight of the acid and having about 20-60 % by weight of the acid neutralized with sodium ion, or zinc ion, or magnesium ion, or combinations thereof, and wherein the ionomer resin has a melt index of about 0.5-50. A suitable thermoplastic interlayer can also be stiff polyvinyl butyral having a low level of plasticization, or polyurethane. Preferably, a suitable polymer has a Storage Young's Modulus of 100-1,000 MPa (mega Pascals) at 1.0 Hz and 25° C., as determined according to ASTM D 5026-95a. A suitable polymer interlayer can also be based on an in situ cured resin such as an acrylic or polyurethane system. Adhesion between receptor and thermoplastic interlayer may be enhanced chemically by treating the receptor with a chemical coupling agent, such as silane-based compounds and the like. Adhesion between receptor and thermoplastic interlayer may be enhanced mechanically by roughening the receptor surface by means such as machining, knurling, sand blasting and the like.

The laminate can be fabricated according to known and conventional glass lamination techniques, with the exception that the laminate must have holes that will accept the receptor and attachment means, and the thermoplastic interlayer must form an adhesive bond with the glass surfaces and also the receptor in such a manner that the interlayer, the receptor, and the glass surfaces are joined with a suitable adhesive force. Lamination temperatures can be dependent on the conditions of the lamination, including the pressure and the type of materials being laminated. Typically, temperatures above 100° C. can be required to obtain a laminate of the present invention. One skilled in the art would know the proper lamination conditions to use. Examples of fabrication methods for thermoplastics include nip-roll prepress followed by autoclaving and vacuum bagging and autoclaving. Examples for resin laminates include liquid damming of the components, addition of the liquid resin followed by ultraviolet curing, thermal curing or catalytically-induced curing.

### EXAMPLES

The following Examples are presented to further illustrate the present invention. The Examples are not intended to limit the scope of the invention in any manner, nor should they be used to define the claims or specification in any manner that is inconsistent with the invention as claimed and/or as described herein.

Example 1 consists of a bolted glass receptor system as described in FIG. 1. The system comprised a first and a second glass ply bonded together by an ethylene/acrylic acid copolymer ionomer, available from E.I. DuPont de Nemours and Company under the tradename of SentryGlas® Plus, and further comprised a stainless steel receptor for an attachment means. The receptor that had one open end for receiving an attachment means and one closed end was embedded in the interlayer on all sides with the exception of the open end which was exposed at the surface of the first glass ply. The receptor did not pass below the surface of the second ply of glass. The polymer-contacting surface of the receptor was knurled to enhance mechanical adhesion between the steel and polymer. The internal surface of the steel receptor was threaded for the attachment means. The system was fabricated by assembling the individual components and laminating by vacuum bagging and applying pressure at elevated temperatures. A method of ensuring good polymer flow around the receptor is to punch-out individual rings of DuPont SentryGlas® Plus with an internal diameter matched to the external diameter of the receptor and an external diameter matching the internal diameter of the hole in the glass. The thermoplastic interlayer was built up around the receptor with a series of DuPont SentryGlas® Plus rings. During autoclaving, the thermoplastic interlayer melted, flowed and welded to the rest of the thermoplastic interlayer forming the major in plane polymer component of the laminate. Bubble-free laminates were fabricated that exhibit good adhesion between glass, steel receptor and interlayer.

Example 2 consists of a bolted glass receptor system, a first and a second glass ply bonded together by a thermoplastic interlayer of DuPont SentryGlas® Plus as described in FIG. 2. In this example a stainless steel receptor was a variant of that used in Example 1, where an additional lip was fabricated at the closed end of the receptor. The internal surface of the receptor was threaded for the attachment means and the polymer-contacting surface was knurled to promote adhesion. DuPont SentryGlas® Plus polymer rings were built up around the receptor during fabrication and a solid disk of DuPont SentryGlas® Plus placed on the bottom surface, where the lips extended. The receptor/ DuPont SentryGlas® Plus assembly was assembled with glass and a DuPont SentryGlas® Plus interlayer sheet, and laminated by vacuum bagging and applying pressure at elevated temperatures

Example 3 consists of a bolted glass stainless steel receptor, a first and a second glass ply bonded together by a thermoplastic interlayer of DuPont SentryGlas® Plus as described in FIG. 3 and is a variation of Example 2 except that the stainless steel receptor passed through both plies of glass, the closed end of the receptor being flush with the exposed surface of the second glass ply. The internal surface of the receptor was threaded for the attachment means and the polymer-contacting surface knurled to promote adhesion. Fabrication consists of punching a hole in the DuPont SentryGlas® Plus interlayer, assembling rings of SentryGlas® Plus around the receptor, assembling the interlayer, rings, receptor and glass and laminating by vacuum bagging and applying pressure at elevated temperatures sufficient to cause the polymer to flow.

Example 4 consists of a bolted glass stainless steel receptor, a first and a second glass ply bonded together by a thermoplastic interlayer of SentryGlas® Plus as described in FIG. 4 and was a variation of Example 3 except that the receptor further comprised a lip that projects from the bottom portion of the closed end of the receptor essentially parallel the surface of the glass. The lip was bonded to the glass surface with a thin layer of DuPont SentryGlas® Plus. The internal surface of the receptor was threaded for the attachment means and the polymer-contacting surface knurled to promote adhesion. Fabrication consisted of punching a hole in the DuPont SentryGlas® Plus interlayer, assembling rings of DuPont SentryGlas® Plus around the receptor including a larger outer diameter ring to seal the lip to the top surface of the glass, assembling the interlayer, rings, receptor and glass and laminating by vacuum bagging and applying pressure at elevated temperatures sufficiently hot to cause the polymer to flow.

Example 5 consists of a bolted glass stainless steel receptor, a first and a second glass ply bonded together by a thermoplastic interlayer of DuPont SentryGlas® Plus as described in FIG. 5 and was a variation of Example 1 except that the receptor comprised of a countersunk geometry to allow flush mounting with one internal glass surface. The internal surface of the receptor was threaded for attachment means. The countersunk receptor wall was bonded to the countersunk glass hole with a thin layer of the DuPont SentryGlas® Plus interlayer. This was achieved by molding a thin cup washer of DuPont SentryGlas® Plus at elevated temperatures that conformed to the countersunk receptor profile. The countersunk stainless steel receptor, DuPont SentryGlas® Plus cup washer, DuPont SentryGlas® Plus interlayer and glass were assembled and laminated by vacuum bagging and applying pressure at elevated temperatures.

Example 6 consists of a bolted glass stainless steel receptor system, a first and a second glass ply bonded together by a thermoplastic interlayer of DuPont SentryGlas® Plus as described in FIG. 7 and was a variation of Example 5 except that the receptor comprised a countersunk geometry to allow flush mounting with one external glass surface. The shaft of the receptor was knurled to promote adhesion and continued through the laminate and until the open end is flush with the external surface of the other glass ply. Attachment of the threaded fastener was made to the open end of the receptor. The system was assembled by first adhesively attaching the countersunk portion of the receptor to one glass ply using an epoxy adhesive. Rings of DuPont SentryGlas® Plus polymer were built up around the cylindrical portion of the receptor. A hole was punched in the DuPont SentryGlas® Plus interlayer, and the glass, receptor, and polymer system assembled and laminated by vacuum bagging and applying pressure at elevated temperatures, sufficiently high to make the polymer flow.

Example 7 consisted of a bolted glass stainless steel receptor system, a first and a second glass ply bonded together by a thermoplastic interlayer of DuPont SentryGlas® Plus as described in FIG. 8 and was a variation of Example 3 except that the receptor was a dual receptor that was open on each end to both exposed glass surfaces, and able to accept an attachment means from either glass surface. The polymer-contacting surface of the receptor was knurled to enhance mechanical adhesion between steel and polymer. The internal surface of the steel receptor was threaded for the attachment means. Fabrication consisted of punching a hole in the DuPont SentryGlas® Plus interlayer, assembling rings of DuPont SentryGlas® Plus around the receptor, assembling the interlayer, rings, receptor and glass and laminating by vacuum bagging and applying pressure at elevated temperatures sufficient to cause the polymer to flow.

Example 8 consists of a bolted glass stainless steel receptor system, a first and a second glass ply bonded together by a thermoplastic interlayer of DuPont SentryGlas® Plus as described in FIG. 9 and was a variation of Example 7 except that the receptor in FIG. 9 further comprised a lip that projected into the interlayer interspersed between the two glass plies. The polymer-contacting surface of the receptor was knurled to enhance mechanical adhesion between steel and polymer. The internal surface of the steel receptor was threaded for attachment means. Fabrication consists of punching a hole in the DuPont SentryGlas® Plus interlayer, assembling rings of DuPont SentryGlas® Plus around the receptor. The DuPont SentryGlas® Plus rings contacting the internal lip are extended past the glass hole diameter out to the diameter of the internal receptor lip. The diameter of the punched hole in the interlayer was matched to that of the internal receptor lip. The DuPont SentryGlas® Plus interlayer, stainless steel receptor, DuPont SentryGlas® Plus rings and glass were assembled and laminated by vacuum bagging and applying pressure at elevated temperatures sufficient to cause the polymer to flow.

Example 9 consisted of a bolted glass poly(acetal) DuPont Delrin® receptor system, a first and a second glass ply bonded together by a thermoplastic interlayer of DuPont SentryGlas® Plus as described in FIG. 10 where the receptor device was embedded within the laminate and bonded directly to the DuPont SentryGlas® Plus interlayer. The receptor provided an internal solid surface for connection with a fastener device. The interlayer-contacting surfaces of the DuPont Delrin® receptor was knurled to enhance mechanical adhesion between DuPont Delrin® and DuPont SentryGlas® Plus interlayer. The internal surface of the DuPont Delrin® receptor was a straight hole for attachment means. The system was assembled by first cutting a hole in the DuPont SentryGlas® Plus interlayer of diameter equal to the DuPont Delrin® receptor. Two thin disks of DuPont SentryGlas® Plus interlayer were placed on the large flat surfaces of the DuPont Delrin® receptor and assembled with the DuPont SentryGlas® Plus interlayer and glass. The assembly was laminated by vacuum bagging and applying pressure at elevated temperatures, sufficient to cause the polymer to flow.

What is claimed is:

1. A direct-point attachment glazing (bolted glass) system comprising: (1) a polymer interlayer (2) at least one sheet of glass; (3) at least one receptor for an attachment means; and (4) at least one attachment means, wherein the polymer interlayer is bonded on at least one surface to at least one sheet of glass, and wherein at least one receptor is adhesively bonded to the glass by the polymer interlayer in such a way that the receptor is positioned to mechanically accept the attachment means.

2. The bolted glass system of claim 1, wherein said interlayer comprises a thermoplastic polymer composition having a Storage Young's Modulus of 100-1,000 MPa (mega Pascals) at 1.0 Hz and 25° C., as determined according to ASTM D 5026-95a.

3. The bolted glass system of claim 2, wherein said interlayer consists essentially of a water insoluble salt of a copolymer of ethylene and methacrylic acid or acrylic acid containing 14-28% by weight of the acid and having about 20-60% by weight of the acid neutralized with sodium ion, or zinc ion, or magnesium ion, or combinations thereof, and the ionomer resin has a melt index of about 0.5-50.

4. The bolted glass system of claim 3 wherein the system is constructed as shown in any of FIGS. 1 through 11.

5. The bolted glass system of claim 3 wherein the system is constructed as shown in FIG. 1.

6. The bolted glass system of claim 3 wherein the system is constructed as shown in FIG. 2.

7. The bolted glass system of claim 3 wherein the system is constructed as shown in FIG. 3.

8. The bolted glass system of claim 3 wherein the system is constructed as shown in FIG. 4.

9. The bolted glass system of claim 3 wherein the system is constructed as shown in FIG. 5.

10. The bolted glass system of claim 3 wherein the system is constructed as shown in FIG. 6.

11. The bolted glass system of claim 3 wherein the system is constructed as shown in FIG. 7.

12. The bolted glass system of claim 3 wherein the system is constructed as shown in FIG. 8.

13. The bolted glass system of claim 3 wherein the system is constructed as shown in FIG. 9.

14. The bolted glass system of claim 3 wherein the system is constructed as shown in FIG. 10.

15. The bolted glass system of claim 3 wherein the system is constructed as shown in FIG. 11.
